(19) United States
(12) Patent Application Publication
(10) Pub. No.: US 2024/0270204 A1
(43) Pub. Date: Aug. 15, 2024

(54) METHODS AND SYSTEMS OF USING AUGMENTED REALITY FOR VALIDATING THE PROPER FASTENING OF A VEHICLE SEAT

(71) Applicant: STATE FARM MUTUAL AUTOMOBILE INSURANCE COMPANY, Bloomington, IL (US)

(72) Inventors: Catherine Espel-Logan, Plano, TX (US); Tyler Hittle, Bloomington, IL (US); Ryan Hoffman, Normal, IL (US); Nicole Ward, Bloomington, IL (US); Brian Mark Fields, Phoenix, AZ (US)

(21) Appl. No.: 18/623,680

(22) Filed: Apr. 1, 2024

Related U.S. Application Data
(63) Continuation-in-part of application No. 18/416,826, filed on Jan. 18, 2024.
(60) Provisional application No. 63/553,970, filed on Feb. 15, 2024.
(60) Provisional application No. 63/541,659, filed on Sep. 29, 2023.
(60) Provisional application No. 63/530,418, filed on Aug. 2, 2023.
(60) Provisional application No. 63/524,035, filed on Jun. 29, 2023.
(60) Provisional application No. 63/488,042, filed on Mar. 2, 2023.
(60) Provisional application No. 63/445,879, filed on Feb. 15, 2023.

(51) Int. Cl. B60R 22/48; G06T 7/70; G06T 11/60; G06V 20/20; G06V 20/59

(52) U.S. Cl. CPC B60R 22/48; G06T 7/70; G06T 11/60; G06V 20/20; G06V 20/59; B60R 2022/4808; B60R 2022/4866; G06T 2200/24; G06T 2207/30196; G06T 2207/30268

(57) ABSTRACT

Methods and systems for validating proper fastening of vehicle seats via an application executing on a mobile computing device. The method and systems may include: obtain input data via an input interface of the mobile computing device, the input data including one or more of vehicle data, vehicle seat data, or child data; obtain underlay layer data generated by an image sensor of the mobile computing device; generate overlay layer data based upon the input data and/or the underlay layer data, the overlay layer data including an indication associated with proper fastening of the vehicle seat; corelate the overlay layer data with the underlay layer data; the one or more processors to create an AR display based upon the correlation; and/or present the AR display via an AR interface of the mobile computing device.

### CROSS REFERENCE TO RELATED APPLICATIONS

The present application claims the benefit of U.S. Provisional Patent Application No. 63/553,970, entitled “Methods and Systems of Using Augmented Reality for Validating the Proper Fastening of a Vehicle Seat,” filed on Feb. 15, 2024 and is a continuation-in-part of U.S. patent application Ser. No. 18/416,826, entitled “Methods and Systems of Using Augmented Reality for Visualizing the Proper Fastening of a Vehicle Seat,” filed on Jan. 18, 2024, which claims the benefit of (1) U.S. Provisional Patent Application No. 63/541,659, entitled “Methods and Systems of Using Augmented Reality for Visualizing the Proper Fastening of a Vehicle Seat,” filed on Sep. 29, 2023, (2) U.S. Provisional Patent Application No. 63/530,418, entitled “Methods and Systems for Generating, Maintaining, and Using Information Related to Vehicle Seats Stored on a Blockchain,” filed on Aug. 2, 2023, (3) U.S. Provisional Patent Application No. 63/524,035, entitled “Methods and Systems of Using Augmented Reality for Visualizing the Proper Fastening of a Vehicle Seat,” filed on Jun. 29, 2023, (4) U.S. Provisional Patent Application No. 63/488,042, entitled “Methods and Systems for Automated Vehicle Seat Replacement,” filed on Mar. 2, 2023, and (5) U.S. Provisional Patent Application No. 63/445,879, entitled “Methods and Systems for Simulating a Vehicle Seat in a Vehicle,” filed on Feb. 15, 2023, each of which are hereby expressly incorporated by reference herein in their entirety.

### TECHNICAL FIELD

The present disclosure generally relates to augmented reality (AR) technology and machine vision algorithms, techniques, platforms, methods, and systems for validating proper fastening of vehicle seats.

### BACKGROUND

Properly fastened vehicle seats help ensure safe travel of toddlers, children, and animals. Vehicle accidents and collisions that occur while a vehicle seat is improperly fastened or improperly buckled may result in a restraint of the vehicle seat failing to secure its occupant, potentially resulting serious harm.

However, vehicle operators often still struggle with properly fastening vehicle seats. One of the primary difficulties is the growing complexity and lack of standardization of vehicle seats. Modern vehicle seats often feature multiple straps, harnesses, anchors, and buckles. Additionally, all of these components typically need to be fastened in a particular order with the fastening elements coupled in a particular way to ensure that the child is safely fastened. If the fastening elements are not coupled in the correct manner, the occupant may not be fully protected in the event of a vehicle accident or collision.

The conventional techniques for validating the fastening of vehicle seats may include additional encumbrances, inefficiencies, drawbacks, and/or challenges.

### SUMMARY

In some embodiments, a computer-implemented method of using augmented reality (AR) for validating proper fastening of a vehicle seat via an application executing on a mobile computing device may be provided. The method may be implemented via one or more local or remote processors, transceivers, sensors, servers, memory units, mobile devices, wearables, smart devices, smart glasses, augmented reality (AR) glasses or headsets, virtual reality (VR) glasses or headsets, extended or mixed reality (MR) glasses or headsets, voice bots, chat bots, ChatGPT bots, ChatGPT-based bots, and/or other electronic or electrical components, which may be in wired or wireless communication with one another. For example, in one instance, the method may include: (1) the application causing one or more processors of the mobile computing device to obtain input data an input interface of the mobile computing device, the input data including one or more of vehicle data, vehicle seat data, or child data; (2) the application causing the one or more processors to obtain underlay layer data generated by an image sensor of the mobile computing device; (3) the application causing the one or more processors to generate overlay layer data based upon the input data and/or the underlay layer data, the overlay layer data including an indication associated with proper fastening of the vehicle seat; (4) the application causing the one or more processors to corelate the overlay layer data with the underlay layer data; the application causing the one or more processors to create an AR display based upon the correlation; and/or (5) the application causing the one or more processors to present the AR display via an AR interface of the mobile computing device. The method may include additional, less, or alternate actions, including those discussed elsewhere herein.

In other embodiments, a mobile computing system for using an augmented reality (AR) enabled application to validate proper fastening of a vehicle seat may be provided. The mobile computing system may include, or be configured to work with, one or more local or remote processors, transceivers, sensors, servers, memory units, mobile devices, wearables, smart devices, smart glasses, augmented reality (AR) glasses or headsets, virtual reality (VR) glasses or headsets, extended or mixed reality (MR) glasses or headsets, voice bots, chat bots, ChatGPT bots, ChatGPT-based bots, and/or other electronic or electrical components, which may be in wired or wireless communication with one another. For example, in one instance, the mobile computing device may comprise (i) an image sensor; (ii) one or more processors; and (iii) a non-transitory program memory coupled to the one or more processors and storing executable instructions that, when executed by the one or more processors, cause the mobile computing system to: (1) obtain input data via an input interface, the input data including one or more of vehicle data, vehicle seat data, or child data; obtain underlay layer data generated by the image sensor; (2) generate overlay layer data based upon the input data and/or the underlay layer data, the overlay layer data including an indication associated with proper fastening of the vehicle seat; (3) correlate the overlay layer data with the underlay layer data; (4) create an AR display based upon the correlation; and/or (5) present the AR display via an AR interface. The mobile computing system may be configured to include additional, less, or alternate functionality, including that discussed elsewhere herein.

In yet other embodiments, a tangible, non-transitory computer-readable medium storing executable instructions of using augmented reality (AR) for validating proper fastening of a vehicle seat may be provided. The executable instructions, when executed by one or more processors of a mobile computing system, cause the mobile computing system to: (1) obtain input data via an input interface of a mobile computing device, the input data including one or more of vehicle data, vehicle seat data, or child data; (2) obtain underlay layer data generated by an image sensor of the mobile computing device; (3) generate overlay layer data based upon the input data and/or the underlay layer data, the overlay layer data including an indication associated with proper fastening of the vehicle seat; (4) correlate the overlay layer data with the underlay layer data; create an AR display based upon the correlation; and/or (5) present the AR display via an AR interface of the mobile computing device. The instructions may direct additional, less, or alternate functionality, including that discussed elsewhere herein.

Advantages will become more apparent to those of ordinary skill in the art from the following description of the preferred embodiments, which have been shown and described by way of illustration. As will be realized, the present embodiments may be capable of other and different embodiments, and details are capable of modification in various respects. Accordingly, the drawings and description are to be regarded as illustrative in nature and not as restrictive.

### BRIEF DESCRIPTION OF THE DRAWINGS

The figures described below depict various embodiments of the systems and methods disclosed herein. It should be understood that the figures depict illustrative embodiments of the disclosed systems and methods, and that the figures are intended to be exemplary in nature. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing environment for implementing the methods and systems of using augmented reality (AR) for validating the proper fastening of a vehicle seat via an application executing on a mobile computing device;

FIG. 2A depicts an exemplary server for implementing the computer-implemented methods and computer systems of using AR for validating the proper fastening of a vehicle seat via an application executing on a mobile computing device;

FIG. 2B depicts an exemplary mobile computing device for implementing the computer-implemented methods and computer systems of using AR for validating the proper fastening of a vehicle seat via an application executing on a mobile computing device;

FIG. 3 depicts a diagram of an exemplary machine learning training module for implementing the computer-implemented methods and computer systems of using AR for validating the proper fastening of a vehicle seat via an application executing on a mobile computing device;

FIG. 4 depicts an exemplary user interface (UI) for implementing the computer-implemented methods and computer systems of using AR for validating the proper fastening of a vehicle seat via an application executing on a mobile computing device;

FIG. 5A depicts an exemplary environment for implementing the computer-implemented methods and computer systems of using AR for validating the proper fastening of a vehicle seat via an application executing on a mobile computing device;

FIG. 5B depicts an exemplary environment for implementing the computer-implemented methods and computer systems of using AR for validating the proper fastening of a vehicle seat via an application executing on a mobile computing device;

FIGS. 6A-6E depict exemplary AR displays for implementing the computer-implemented methods and computer systems of using AR for validating the proper fastening of a vehicle seat via an application executing on a mobile computing device; and

FIG. 7 depicts an exemplary computer-implemented method of using AR for validating the proper fastening of a vehicle seat via an application executing on a mobile computing device.

The figures depict the present embodiments for purposes of illustration only. One skilled in the art will readily recognize from the following discussion that alternate embodiments of the structures and methods illustrated herein may be employed without departing from the principles of the invention described herein.

### DETAILED DESCRIPTION

To assist vehicle operators with the fastening of vehicle seats, computer systems and computer-implemented methods for augmented reality (AR) technology for validating the proper fastening of a vehicle seat are presented.

In one aspect, a computer system may visualize data associated with proper fastening of a vehicle seat via an AR imaging system of a mobile computing device. In some embodiments, the mobile computing device executes an application stored in a memory to provide guidance to a user associated with proper fastening of the vehicle seat. The application may generate one or more interfaces to provide the guidance. For example, the application may cause one or more sensors of the mobile computing device to capture underlay layer data representative of the vehicle seat. In some embodiments, underlay layer data includes images of the vehicle seat captured from one or more angles. Upon capturing the underlay layer data, the application may analyze the underlay data (and/or other data) to generate overlay layer data associated with the proper fastening of the vehicle seat. The application may then correlate the overlay layer data to the underlay layer data to generate an AR display that visualizes information associated with the proper fastening of the vehicle seat. The application may then present the AR display via an AR interface displayed by the mobile computing device.

According to further aspects, the mobile computing device may determine whether the vehicle seat has been properly fastened via the application executing a machine learning model. For example, after fastening a vehicle seat, one or more sensors of the AR imaging system may capture image data of the vehicle seat. In some embodiments, image data includes images captured from one or more angles. Upon receiving the image data, the mobile computing device may analyze the image data to: (i) recognize and/or identify the vehicle seat (ii) determine whether an occupant of the vehicle seat is properly fastened into the seat, and/or (iii) determine whether the vehicle seat is properly secured to the vehicle. The application may apply machine learning techniques during this analysis. In some embodiments, the mobile computing device may also analyze the image data to determine an error in the fastening of the vehicle seat and present the user with specific instructions on how to rectify the error.

In some embodiments, the mobile computing device visualizes data associated with the proper fastening of the vehicle seat and/or determines whether the vehicle seat has been properly fastened in real-time or near real-time as the AR imaging device captures the image data.

It should be noted that the term “vehicle seats,” as it is generally used herein, may refer to any vehicle seat that are placed into a vehicle to accommodate and/or otherwise protect toddlers and other small children. Accordingly, the term “vehicle seats” may refer to “toddler seats,” “child seats,” “safety seats,” “booster seats,” etc. In one embodiment, the vehicle seat may be a toddler's seat (e.g., a rear-facing, toddler's vehicle seat) designed to safely accommodate toddlers under a specific age, height, and/or weight (e.g., vehicle seats for toddlers aged two and under). In another embodiment, the vehicle seat may be a child seat (e.g., a forward-facing, children's vehicle seat) designed to safely accommodate children between specific age, height, and/or weight ranges (e.g., vehicle seats for children between 50 lbs. and 100 lbs.). In yet another embodiment, the vehicle seat may be a safety seat (e.g., an adult's booster seat) to safely accommodate individuals at any age but between specific height, and/or weight ranges (e.g., vehicle seats for adults between 3 ft. tall and 5 ft. tall). In still other embodiments, the vehicle seat is a pet seat or kennel. Accordingly, in these embodiments, the disclosed techniques may be applied to ensure the proper fastening of animal occupants of the vehicle seat.

The present disclosure may include improvements in computer functionality or in improvements to other technologies at least because the disclosure herein discloses systems and methods for AR visualization of vehicle seats to prevent harm to occupants of vehicle seats. The systems and methods herein may utilize AR analysis techniques to automatically determine whether a vehicle seat is properly fastened in real-time or near real-time. Accordingly, users of the system are provided real-time or near real-time feedback on the properness of how the vehicle seat is fastened, increasing the likelihood of the user taking a remedial action to correct an improperly fastened vehicle seat.

Additional improvements may also include practical applications for the improvement of technology. For example, the system, utilizing AR technology, may be able to determine whether a vehicle seat is properly fastened in real-time while an operator is securing a child or toddler, which would make trips far safer. As another example, the system presents an ease in accessibility, allowing individuals with certain conditions (e.g., individuals with poor vision, individuals with mental disabilities, senior citizens etc.) to be able to properly fasten vehicle seats. Further, the present disclosure solves the above-described problem related to the proliferation of improperly fastened vehicle seats, to further improve the safety of vehicle passengers.

### Exemplary Augmented Reality (AR), Extended or Mixed Reality (MR), and Virtual Reality (VR) Techniques

The present embodiments may involve, inter alia, the use of augmented reality, extended and/or mixed reality, and/or virtual reality techniques.

The term “augmented reality” (AR) may refer to generating digital content (or “overlay layer data”) which is overlaid onto a physical environment via an AR display of a mobile computing device. In some embodiments, the mobile computing device captures image data of the physical environment (e.g., “underlay layer data”) which may be generated by one or more image sensors connected to the mobile computing device. By correlating the underlay layer data with the overlay layer data, the mobile computing device is able to present the overlay layer day in a manner that aligns with the perspective of the user of the mobile computing device. The overlay layer data may be transparent or semi-transparent such that the user of the mobile computing device may still be able to view the underlay layer data. In some embodiments, the overlay layer data may be either two-dimensional (2D) or three-dimensional (3D) objects and/or environments. The AR display may include virtual images, text, models, sounds, animations, videos, instructions, multimedia and/or other digitally-generated content.

The term “virtual reality” (VR) may refer to generating digital content (or “simulated data”) which is generated via a VR display of an VR viewer device. In some embodiments, the VR display may only display the simulated data. Alternatively, in some embodiments, the VR viewer device may include one or more image sensors to capture image data of a physical environment (or “physical data”). In these embodiments, simulated data may be considered overlay layer data and virtual representations of the physical data may be considered underlay layer data. By correlating the simulated data with the virtual representations of the physical data, the VR viewer device is able to present the simulated data in a manner that aligns with the perspective of the user of the VR viewer device.

Additionally, in these embodiments, the transparency of the simulated data may be changed by a user of the VR device to increase or decrease the amount by which the user can see the virtual representations of the physical data. For example, the simulated data may be completely opaque such that the user of the VR viewer device may not be able to view the virtual representations of the physical data. As another example, the simulated data may be transparent or semi-transparent such that the user of the VR viewer device may still be able to view the virtual representations of the physical data. In some embodiments, the simulated data is generated based upon the physical data. The simulated data may be either two-dimensional (2D) or three-dimensional (3D) objects and/or environments. In some embodiments, the simulated data may be viewed from multiple angles within a simulated environment and interacted with via one or more interactive objects (e.g., controllers, gloves, etc.). The VR display may include virtual images, text, models, sounds, animations, videos, instructions, multimedia and/or other digitally-generated content.

The terms “extended reality” and/or “mixed reality” (MR) may refer to generating digital content (or “simulated overlay layer data”) which is overlayed onto a physical environment via an MR display of an MR viewer device. In some embodiments, the MR viewer device may capture image data of the physical environment (e.g., “physical underlay layer data”) using one or more image sensors. By correlating the physical underlay layer data with the simulated overlay layer data, the MR viewer device is able to present the simulated overlay layer day in a manner that aligns with the perspective of the user of the MR viewer device.

Meanwhile, the transparency of the simulated overlay layer data may be changed by a user of the MR device to increase or decrease the amount by which the user can see the physical underlay layer data. For example, the simulated overlay layer data may be completely opaque such that a user of the MR viewer device may not be able to view the portion of the physical underlay layer data behind the simulated overlay layer data. As another example, the simulated overlay layer data may be transparent or semi-transparent such that the user of the MR viewer device may still be able to view the physical data through the simulated overlay layer data. In some embodiments, the simulated overlay layer data is generated based upon the physical underlay layer data. In certain embodiments, the simulated overlay layer data may be either two-dimensional (2D) or three-dimensional (3D) objects and/or environments. In some embodiments, the simulated overlay may be viewed from multiple angles within a simulated environment and interacted with via one or more interactive objects (e.g., controllers, gloves, etc.). The MR display may include virtual images, text, models, sounds, animations, videos, instructions, multimedia and/or other digitally-generated content.

It should be appreciated that the term “mobile computing device” used herein may include the “mobile computing device,” the “VR viewer device,” and/or the “MR viewer device” described above. Further, although many AR viewer devices are “worn” over the head of the user, in some embodiments, an AR viewer device may be a screen of a mobile computing device. Accordingly, any reference to “wearing” an AR viewer device is provided for ease of explanation, and not to limit the disclosed AR viewer devices to worn AR viewer devices.

### Exemplary Machine Vision, Image Recognition, and Object Identification Techniques

The present embodiments may involve, inter alia, the use of machine vision, image recognition, object identification, and/or other image processing techniques and/or algorithms. In particular, image data may be input into one or more machine vision programs described herein that are able to recognize, track, and/or identify vehicle seats and/or specific features of vehicle seats (e.g., the connecting and/or fastening points between the vehicle seats and the vehicle) in and across the image data. Additionally, such machine vision programs may also be able to analyze the image data itself to determine the quality of the image data, select one or more images from a plurality of image data, and/or the like.

In certain embodiments, the systems, methods, and/or techniques discussed herein may process and/or analyze the image data via image classification, image recognition, and/or image identification techniques (e.g., query by image content (QBIC), optical character recognition (OCR), pattern and/or shape recognition, histogram of oriented gradients (HOG) and/or other object detection methods), two dimensional image scanning, three dimensional image scanning, and/or the like. In some embodiments, machine learning techniques may also be used in conjunction with any machine vision techniques described herein.

In some embodiments, the methods and systems described herein may utilize focus measure operators and/or accompanying algorithms (e.g., gradient-based operators, Laplacian-based operators, wavelet-based operators, statistics-based operators, discrete cosine transform based operators, and/or the like) to determine a level of focus of the image data. Such operators and/or algorithms may be applied to the image data as a whole or to a portion of the image data. The resulting level of focus may be a representation of the quality of the image data. If the level of focus (and, thus, the quality) of the image data falls below a threshold value, subsequent image data may be captured.

In certain embodiments where the image data includes two or more frames of image data (e.g., when the image data captured via burst imaging techniques, video techniques, etc.), a single frame from the two or more frames may be selected from the image data for processing. In some embodiments, the single frame is selected based upon the quality of the image data in the frames. In these embodiments, the frame with the highest relative quality among the captured frames may be selected.

### Exemplary Machine Learning Techniques

The present embodiments may involve, inter alia, the use of cognitive computing, predictive modeling, machine learning, and/or other modeling techniques and/or algorithms. In particular, image data may be input into one or more machine learning programs described herein that are trained and/or validated to determine the properness of a vehicle seat fastening.

In certain embodiments, the systems, methods, and/or techniques discussed herein may use heuristic engines, algorithms, machine learning, cognitive learning, deep learning, combined learning, predictive modeling, and/or pattern recognition techniques. For instance, a processor and/or a processing element may be trained using supervised machine learning, unsupervised machine learning, or semi-supervised machine learning and the machine learning program may employ a neural network, which may be a convolutional neural network (CNN), a fully convolutional neural network (FCN), a deep learning neural network, and/or a combined learning module or program that learns in two or more fields or areas of interest. Machine learning may involve identifying and/or recognizing patterns in existing data in order to facilitate making predictions, estimates, and/or recommendations for subsequent data. Models may be created based upon example inputs in order to make valid and reliable outputs for novel inputs.

Additionally or alternatively, the machine learning programs may be trained and/or validated using labeled training data sets, such as sets of image data of properly fastened vehicle seats and corresponding labels of whether the vehicle seats were properly fastened, etc. The machine learning programs may utilize deep learning algorithms that may be primarily focused on pattern recognition and may be trained after processing multiple examples.

In supervised machine learning, a processing element identifies patterns in existing data to make predictions about subsequently received data. Specifically, the processing element may be “trained” using training data, which includes example inputs and associated example outputs. Based upon the training data, the processing element may generate a predictive function which maps outputs to inputs and may utilize the predictive function to generate outputs based upon data inputs. The exemplary inputs and exemplary outputs of the training data may include any of the data inputs or outputs described herein. In the exemplary embodiment, the processing element may be trained by providing it with a large sample of data with known characteristics or features. In this way, when subsequent novel inputs are provided the processing element may, based upon the discovered association, accurately predict the correct output.

In unsupervised machine learning, the processing element finds meaningful relationships in unorganized data. Unlike supervised learning, unsupervised learning does not involve user-initiated training based upon example inputs with associated outputs. Rather, in unsupervised learning, the processing element may organize unlabeled data according to a relationship determined by at least one machine learning method/algorithm employed by the processing element. Unorganized data may include any combination of data inputs and/or outputs as described herein.

In semi-supervised machine learning, the processing element may use thousands of individual supervised machine learning iterations to generate a structure across the multiple inputs and outputs. In this way, the processing element may be able to find meaningful relationships in the data, similar to unsupervised learning, while leveraging known characteristics or features in the data to make predictions.

In reinforcement learning, the processing element may optimize outputs based upon feedback from a reward signal. Specifically, the processing element may receive a user-defined reward signal definition, receive a data input, utilize a decision-making model to generate an output based upon the data input, receive a reward signal based upon the reward signal definition and the output, and alter the decision-making model so as to receive a stronger reward signal for subsequently generated outputs.

In some embodiments, the machine learning model may include a neural network, such as a convolutional neural network (CNN) model and/or a fully convolutional neural network (FCN). For example, the CNN may be trained on a set of labeled historical data to produce a binary classification decision as to whether or not a vehicle seat has been properly fastened. Accordingly, the training data may include a first set of images of vehicle seats that are labeled as being properly fastened and a second set of images of vehicle seats that are labeled as being improperly fastened. In some embodiments, the sets of images may include subsets of associated images depicting the same vehicle seat from a plurality of angles and/or orientations.

Generally, the second set of images should include a sufficient number of images of improperly fastened vehicle seats for the machine learning model to identify characteristics that can be accurately associated with improperly fastened vehicle seats. For example, vehicle seats that are not properly fastened can be too tightly fastened in parts and/or too loosely fastened in parts. Therefore, the second set of images may include several images of vehicle seats wherein the vehicle seat is not properly fastened.

According to certain aspects, a composition of the training images may be chosen to avoid biasing the trained machine learning model. In some embodiments, this means that there are roughly the same number of images that represent each characteristic that renders the vehicle seat as improperly fastened. If a particular image is associated with a vehicle seat that exhibits multiple characteristics that render the vehicle seat as improperly fastened, the image may count towards both characteristics.

By training a machine learning model in the disclosed manner, the trained machine learning model may be able to detect any characteristic that renders a vehicle seat as improperly fastened. As such, the need to train component machine learning models to detect individual defects may be avoided.

In some embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in some embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In some embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, the chatbot ML module may be used in conjunction with the machine vision, image recognition, object identification, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### Exemplary Computing Environment

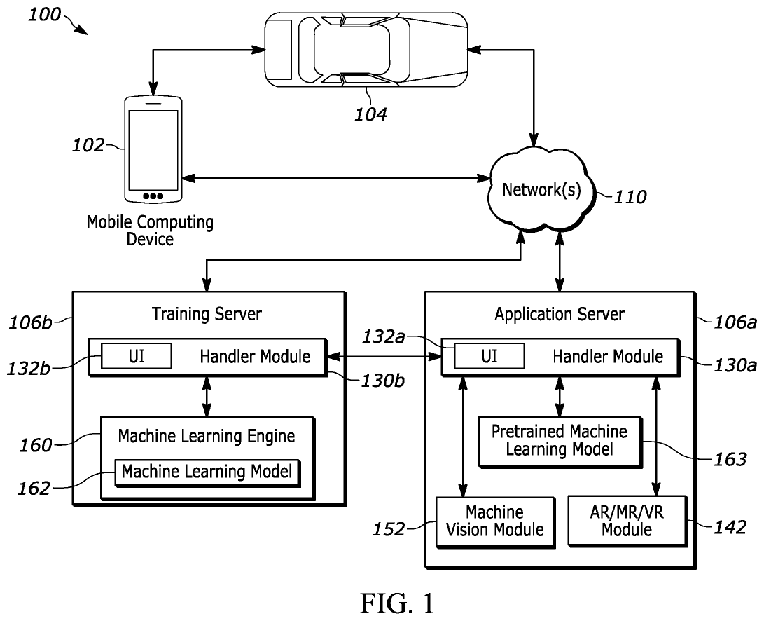

FIG. 1 depicts a diagram of an exemplary computing environment 100. The exemplary computing environment 100 may include a mobile computing device 102, a vehicle 104, an application server 106a, a training server 106b, and/or one or more networks 110.

The mobile computing device 102 may include a wearable device, smart contacts, smart glasses, augmented reality (AR) glasses, virtual reality (VR) headset, extended or mixed reality (MR) glasses or headsets, and/or computing devices such as a tablet, a mobile device, a smartphone or other smart device, a base unit device, or a computer device. Accordingly, the mobile computing device 102 may include a display via which the AR display is presented. Accordingly, the mobile computing device 102 may be configured to overlay AR information (e.g., overlay layer data) included in the AR display onto features of the natural environment within the line of sight of the user of the mobile computing device 102. To determine the line of sight of the user, the mobile computing device 102 may include one or more image sensors (such as a camera) configured to have a field of view (FOV) that generally aligns with the line of the sight of the user and/or an orientation sensor (such as a gyroscope and/or an accelerometer) configured to determine an orientation of the mobile computing device 102. The mobile computing device 102 may be configured to generate an AR display that includes information related to objects within the line of sight of the user in a manner that is accurately overlaid on the natural environment. It should be noted that while FIG. 1 depicts the mobile computing device 102 as a singular, mobile device, the mobile computing device 102 may be a combination of devices (e.g., a combination of a smartphone and smart glasses) and/or need not be or include a mobile device.

In operation, in some embodiments, the mobile computing device 102 may display an AR display featuring a determination of whether a vehicle seat is properly fastened and/or instructions on how to properly fasten a vehicle seat. In these embodiments, the mobile computing device 102 may capture image data of a surrounding environment (e.g., underlay layer data), generate data to be overlayed onto the image data (e.g., overlay layer data), and correlate the captured image data to the generated data to generate an AR display. For example, the mobile computing device 102 may capture underlay data of a passenger sitting in a vehicle seat. The mobile computing device 102 may generate overlay layer data of the vehicle seat's straps and/or buckles when properly fastened (e.g., a 3D model that represents the proper fastening).

Then, the mobile computing device 102 may then correlate the overlay layer data (e.g., the 3D models) with the underlay layer data (e.g., image data representative of the vehicle seat) to generate an AR display that locates the overlay data at the appropriate location within the FOV of the mobile computing device 102 (e.g., the position within the physical environment at which the vehicle seat straps and/or buckles will be located when properly fastened). Similarly, the mobile computing device 102 may generate overlay layer data of text-based and/or auditory instructions for how the user should properly fasten the vehicle seat for display at the appropriate position within the FOV of the mobile computing device 102.

Additionally, in some embodiments, the mobile computing device 102 may process the underlay layer data to (i) determine whether a vehicle seat is properly fastened and/or (ii) provide instructions on how to properly fasten a vehicle seat. For example, the mobile computing device 102 may compare the positioning of the overlaid 3D model of the proper positioning of the vehicle seat straps to the positioning of the vehicle seat's actual vehicle seat straps as represented in the underlay layer data. In some embodiments, proper fastening of the vehicle seat straps may be determined by generating a discrepancy score between the two positions. In these embodiments, the mobile computing device 102 may determine whether the discrepancy score exceeds a threshold discrepancy score. If the discrepancy score exceeds the threshold discrepancy score, the mobile computing device 102 may determine that the vehicle seat is not properly fastened. Conversely, if the mobile computing device 102 determines that the discrepancy score does not exceed the threshold discrepancy score, the mobile computing device 102 may determine that the vehicle seat is properly fastened.

The mobile computing device 102 may configure the AR display to indicate the properness of the fastening. For example, the mobile computing device may generate a text box and/or change how the 3D model of the vehicle seat straps is rendered (e.g., by changing the color and/or brightness of the model).

As another example, the mobile computing device 102 may present instructions on how to properly fasten the vehicle seat. The instructions may be text-based instructions and/or audible instructions. In some embodiments, the mobile computing device 102 may detect a fastening stage to present the appropriate instruction to the user. For example, the mobile computing device 102 may present a first instruction on how to properly fasten a first strap via the AR display. In response to detecting that the first strap is properly fastened, the mobile computing device may then present a second instruction on how to properly fasten a second strap via the AR display.

The vehicle 104 may include a built-in computing system operatively coupled to one or more vehicle systems (e.g., a vehicle sensor system, a vehicle infotainment system, etc.). In these embodiments, the vehicle 104 may also include one or more transceivers and/or one or more network adapters for sending and receiving information over one or more communication networks (e.g., the one or more networks 110). In some embodiments, the vehicle 104 may be communicatively coupled with the mobile computing device 102 (e.g., via one or more network adapters). In some embodiments, one or more sensors (e.g., one or more image sensors and/or imaging devices) of the vehicle may capture image data (e.g., of a vehicle seat) to be used as the underlay data of the mobile computing device 102. In these embodiments, the vehicle 104 may transmit captured image data (e.g., one or more images of the vehicle seat from multiple perspectives) to the mobile computing device 102 (for example over a short-range wireless transmission such as Bluetooth®).

The one or more networks 110 may include the internet, a local area network (LAN), a metropolitan area network (MAN), a wide area network (WAN), a wired network, a Wi-Fi network, a cellular network, a wireless network, a private network, a virtual private network, etc. The one or more networks 110 may facilitate any data communication between/among the mobile computing device 102, the vehicle 104, the application server 106a, and/or the training server 106b via any standard or technology (e.g., GSM, CDMA, TDMA, WCDMA, LTE, 5G, 6G, EDGE, OFDM, GPRS, EV-DO, UWB, IEEE 802 including Ethernet, WiMAX, and/or others).

In some embodiments, the application server 106a may establish a communicative connection with the mobile computing device 102, the vehicle 104, and/or one or more databases, servers, and/or other data repositories via the one or more networks 110. In some embodiments, establishing the connection may include the user of the mobile computing device 102 and/or the operator of the vehicle 104 signing into an account stored with the application server 106a. In some embodiments, establishing the connection may include navigating to a website and/or a web application hosted by the application server 106a. In these embodiments, the mobile computing device 102, as a client, may establish a client-host connection to the application server 106a, as a host. Additionally or alternatively, the mobile computing device 102 may establish the client-host connection via an application run on the mobile computing device 102. In some embodiments, the connection may be through either a third-party connection or a direct peer-to-peer (P2P) connection/transmission.

The application server 106a and/or the mobile computing device 102 may include a handler module 130a, an AR and/or mixed or extended reality (MR) and/or a virtual reality (VR) module 142, a machine vision module 152 and/or a pretrained machine learning model 163. The handler module 130a may include an interactive UI 132a via which, in some embodiments, one or more function calls are received. The application server 106a may include a portion of a memory unit configured to store software and/or computer-executable instructions that, when executed by a processing unit, may cause the one or more of the above-described components to determine whether a vehicle seat has been properly fastened.

In some embodiments, the handler module 130a may implement the interactive UI 132a (e.g., a web-based interface, mobile application server interface, etc.) that may be populated by an AR display viewed via the mobile computing device 102. In particular, the interactive UI 132a may be configured to enable the user and/or the operator to submit the input data. In some embodiments, the handler module 130a may work in conjunction with or be configured to include a chatbot to receive any input data from the user. For example, the interactive UI 132a may interface with the mobile computing device 102 to gather information relating to the vehicle 104, vehicle seats installed in the vehicle 104.

The training server 106b may include a handler module 130b and/or a machine learning engine 160. The handler module 130b may include UI 132b. The machine learning engine 160 may develop and/or store a machine learning model 162. The training server 106b may include a portion of a memory unit configured to store software and/or computer-executable instructions that, when executed by a processing unit, may train, validate, and/or otherwise develop the machine learning model 162 for determining whether a vehicle seat has been properly fastened. In some embodiments, application server 106a and the training server 106b may be the same entity.

Additionally, or alternatively, in some embodiments, the application server 106a, may also assist the selection and/or generation of the overlay data via the mobile computing device 102. For example, the application server 106a may route one or more sets of underlay layer data (e.g., image data, vehicle data, vehicle seat data, child data, etc.) received over the one or more networks 110 to the handler module 130a. The handler module 130a may forward the one or more sets of underlay layer data to the AR, MR, and/or VR module 142 and/or the machine vision module 152. Based upon the underlay layer data and/or the other received data, the AR, MR, and/or VR module 142 may then generate overlay layer data and/or indicators used by the mobile computing device 102 to generate the overlay layer data. For example, the AR, MR, and/or VR module 142 use a vehicle seat identifier to query an object database to obtain 3D model data of a vehicle seat's straps and/or buckles. In some embodiments, some of the functionality described with respect to the AR/MR/VR module 142 may be implemented by an application executing on the mobile computing device 102.

Additionally or alternatively, in some embodiments, the application server 106a, may assist the mobile computing device 102 in determining whether a vehicle seat is properly fastened by using machine learning techniques. In these embodiments, the application server 106a may route one or more sets of input data received over the one or more networks 110 to the handler module 130a. The input data may include one or more images of a fastened vehicle seat as well as other input data (e.g., vehicle data, vehicle seat data, child data, etc.). The handler module 130a may forward the one or more sets of input data to the machine vision module 152 and/or the pretrained machine learning model 163, which may output a determination as to whether the vehicle seat has been properly fastened. In these embodiments, the pretrained machine learning model 163 may be the machine learning model 162 trained, validated, and/or otherwise developed by the training server 106b. The resulting determination may be returned to the handler module 130a which may in turn provides the output of the machine learning model 163 to the mobile computing device 102.

In these embodiments, the training server 106b may train, validate, and/or otherwise develop the machine learning model 162 based upon one or more sets of training image data. The machine learning model 162 may be a binary classification model, such as a CNN, a logistic regression model, a naïve Bayes model, a support vector machine (SVM) model, and/or the like.

Regardless of the type of binary classification model, the binary classifications may be either “properly fastened” as a first classification and “improperly fastened” as a second classification.

Once the training server 106b initially trains and/or initially develops the machine learning model 162, the training server 106b may then validate the machine learning model 162. In some embodiments, the training server 106b segments out a set of validation data may be from the corpus of training data to use when validating model performance. In these embodiments, the training data is divided into a ratio of training data and validation data (e.g., 80% training data and 20% validation data). The machine learning model 162 may be trained using the training data until the machine learning model 162 satisfies a validation metric (e.g., accuracy, recall, area under curve (AUC), etc.) when applied to the validation data. After satisfying the validation metric, the training server 106b may provide model data of the machine learning model 162 such that the mobile computing device 102 and/or the application server 106a is able to implement and/or interface with the model as the pretrained machine learning model 163.

It should be appreciated that while specific elements, processes, devices, and/or components are described as part of the application server 106a, other elements, processes, devices and/or components are contemplated.

### Exemplary Server and Device

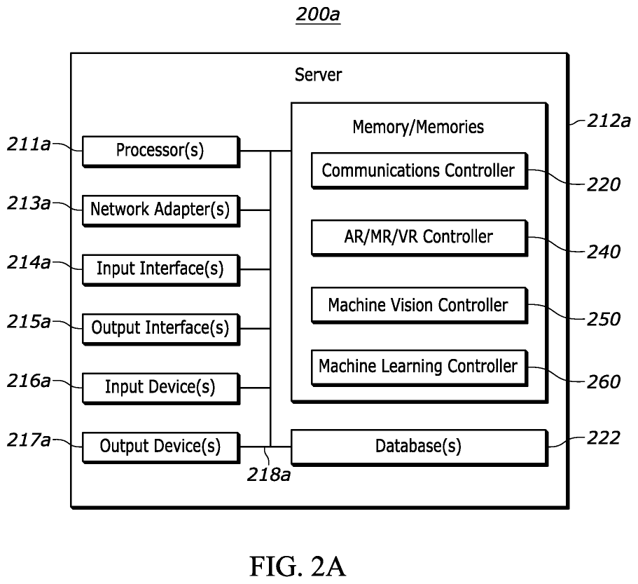

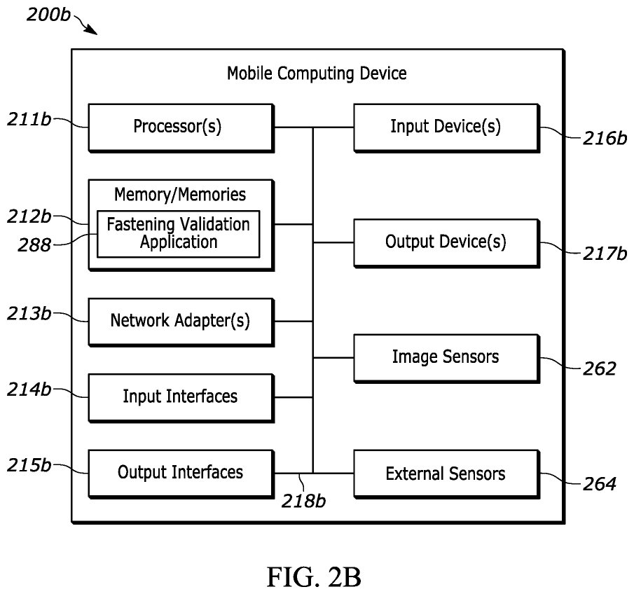

FIG. 2A depicts an exemplary server 200a for using AR to visualize the proper fastening of a vehicle seat. In some embodiments, the server 200a may be the application server 106a or the training server 106b of FIG. 1. The exemplary server 200a may include one or more processors 211a, one or more memories 212a, one or more network adapters 213a, one or more input interfaces 214a, one or more output interfaces 215a, one or more input devices 216a, one or more output devices 217a, and/or one or more databases 222. Any of the components of the exemplary server 200a may be communicatively coupled to one another via a communication bus 218a.

The one or more processors 211a may include one or more central processing units (CPU), one or more coprocessors, one or more microprocessors, one or more graphical processing units (GPU), one or more digital signal processors (DSP), one or more application specific integrated circuits (ASIC), one or more programmable logic devices (PLD), one or more field-programmable gate arrays (FPGA), one or more field-programmable logic devices (FPLD), one or more microcontroller units (MCUs), one or more hardware accelerators, one or more special-purpose computer chips, and one or more system-on-a-chip (SoC) devices, etc.

The one or more memories 212a may include any local short term memory (e.g., random access memory (RAM), read only memory (ROM), cache, etc.) and/or any local long term memory (e.g., hard disk drives (HDD), solid state drives (SSD), etc.). The one or more memories 212a may store computer-readable instructions configured to implement the methods described herein. For example, the one or more memories 212a may store one or more communication controllers 220, one or more augmented reality (AR), extended and/or mixed reality (MR), and/or virtual reality (VR) controllers 240, one or more machine vision controllers 250, and/or one or more machine learning controllers 260. The one or more communication controllers 220 may be executable instructions to send and/or receive electronic data via the one or more network adapters 213a.

The one or more augmented reality (AR), extended and/or mixed reality (MR), and/or virtual reality (VR) controllers 240 may be executable instructions to perform AR, MR, and/or VR techniques. The one or more machine vision controllers 250 may be executable instructions to perform image recognition, object identification, and/or other image processing techniques. The one or more machine learning controllers 260 may be executable instructions to train, validate, and/or develop a machine learning model (e.g., the machine learning model 162 of FIG. 1).

The one or more network adapters 213a may include a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over a communication network (e.g., the one or more networks 110).

The one or more input interfaces 214a may include any number of different types of input units, input circuits, and/or input components via which the one or more processors 211a to communicate with the one or more input devices 216a (such as keyboards and/or keypads, interactive screens (e.g., touch screens), navigation devices (e.g., a mouse, a trackball, a capacitive touch pad, a joystick, etc.), microphones, buttons, communication interfaces, etc.). Similarly, the one or more output interfaces 215a may include any number of different types of input units, input circuits, and/or input components via which the one or more processors 211a to communicate the one or more output devices 217a (display units (e.g., display screens, receipt printers, etc.), speakers, etc.). In some embodiments, the one or more input interfaces 214a and the one or more output interfaces 215a may be combined into input/output (I/O) units, I/O circuits, and/or I/O components.

The one or more databases 222 may include one or more databases, data repositories, etc. For example, the one or more databases 222 may store the training data used to train a machine learning model described herein.

The communications bus 218a may include any dedicated or general-purpose communication bus implementing a bus access protocol that facilitates the communications between the various components of the exemplary server 200a.

The exemplary server 200a may execute one or more applications which may include web-based applications, mobile applications, and/or the like. In some embodiments, the one or more applications may be stored on the one or more memories 212a. In some embodiments, the one or more applications may establish a host-client connection between the exemplary server 200a as the host and the exemplary mobile computing device 200b as the client. In some embodiments, the one or more applications may include instantiations of AI-based programs, such as chatbots, to perform one or more aspects of the application (e.g., prompts to the user to receive data, handling of data with other AI or ML models, processing of data, etc.).

FIG. 2B depicts an exemplary mobile computing device 200b for using AR to visualize the proper fastening of a vehicle seat. In some embodiments, the mobile computing device 200b may be the mobile computing device 102 of FIG. 1. The exemplary mobile computing device 200b may include one or more processors 211b, one or more memories 212b, one or more network adapters 213b, one or more input interfaces 214b, one or more output interfaces 215b, one or more input devices 216b, one or more output devices 217b, one or more image sensors 262, one or more external sensors 264, and/or a fastening validation application 288 stored on the one or more memories 212b. Any of the components of the exemplary mobile computing device 200b may be communicatively coupled to one another via a communication bus 218b.

The one or more processors 211b may include one or more central processing units (CPU), one or more coprocessors, one or more microprocessors, one or more graphical processing units (GPU), one or more digital signal processors (DSP), one or more application specific integrated circuits (ASIC), one or more programmable logic devices (PLD), one or more field-programmable gate arrays (FPGA), one or more field-programmable logic devices (FPLD), one or more microcontroller units (MCUs), one or more hardware accelerators, one or more special-purpose computer chips, one or more system-on-a-chip (SoC) devices, etc.

The one or more memories 212b may include any local short term memory (e.g., random access memory (RAM), read only memory (ROM), cache, etc.) and/or any long term memory (e.g., hard disk drives (HDD), solid state drives (SSD), etc.). The fastening validation application 288 stored in the memory 212b may be configured to implement the fastening validation methods and systems described elsewhere herein.

The one or more network adapters 213b may include a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over a communication network (e.g., the one or more networks 110).

The one or more input interfaces 214b may include any number of different types of input units, input circuits, and/or input components via which the one or more processors 211b to communicate with the one or more input devices 216b (such as keyboards and/or keypads, interactive screens (e.g., touch screens), navigation devices (e.g., a mouse, a trackball, a capacitive touch pad, a joystick, etc.), microphones, buttons, communication interfaces, etc.). Similarly, the one or more output interfaces 215b may include any number of different types of input units, input circuits, and/or input components via which the one or more processors 211b to communicate the one or more output devices 217b (display units (e.g., display screens, receipt printers, etc.), speakers, etc.). In some embodiments, the one or more input interfaces 214b and the one or more output interfaces 215b may be combined into input/output (I/O) units, I/O circuits, and/or I/O components.

The exemplary mobile computing device 200b may execute the fastening validation application 288. In some embodiments, the fastening validation application 288 may establish a host-client connection between the exemplary server 200a as the host and the exemplary mobile computing device 200b as the client. In some embodiments, the fastening validation application 288 and/or another application stored at the memory 212b may include one or more AI-based libraries that implement one or more functions described with respect to the fastening validation application (e.g., prompts to the user to receive data, handling of data with other AI or ML models, processing of data, etc.). In some embodiments, one of these libraries includes a ML chatbot library configured to guide the user while interfacing with the fastening validation application 288. In other embodiments, the AI-based libraries are automatically called by the fastening validation application 288 without detecting inputs via a chatbot interface.

The one or more image sensors 262 may include any image capturing device, unit, and/or component capable of capturing image data. For example, the image sensors 262 may be CMOS image sensors, CCD image sensors, and/or other types of image sensor architectures. The image sensors 262 may be configured to capture convert the values of the component sensors into a file format associated with image data.

The one or more external sensors 264 may include one or more light sensors, one or more proximity sensors, one or more motion sensors, and/or one or more sensors connected to one or more apparatuses and/or systems (e.g., accelerometer sensors, throttle sensors, lane correction sensors, collision sensors, GPS sensors, gyroscopic sensors, etc.). The one or more external sensors 264 may be communicatively coupled to one or more processors 211b and/or the one or more image sensors 262. In some embodiments, the one or more processors 211b may trigger the one or more image sensors 262 to capture image data in response to detecting a stimulus via the one or more external sensors 264. For example, the vehicle 104 may be engaged, a door of the vehicle 104 may be opened, a collision sensor may detect an impact, a motion sensor may detect anomalous vehicle motion, etc.

### Exemplary Machine Learning Training Module

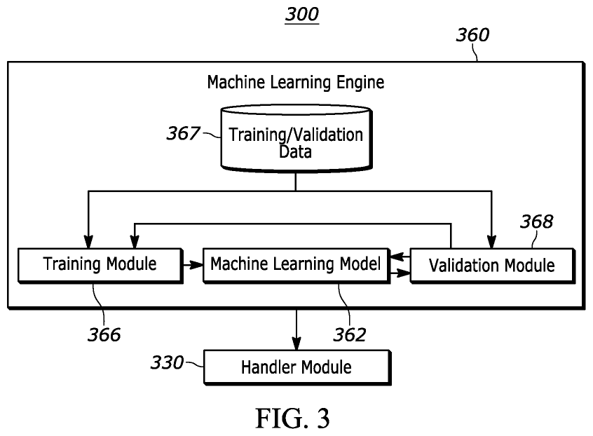

FIG. 3 depicts a diagram of an exemplary machine learning training module 300. The machine learning training module 300 may include a machine learning engine 360 (e.g., the machine learning engine 160 and/or chatbots integrated therewith). The machine learning engine 360 may include training and/or validation data 367, a training module 366 and/or a validation module 368.

The machine learning engine 360 may include a portion of a memory unit (e.g., the one or more memories 212a) configured to store software and/or computer-executable instructions that, when executed by a processing unit (e.g., the one or more processors 211a), may cause the one or more of the above-described components to generate, develop, train, validate, and/or deploy a machine learning model 362 (e.g., the machine learning model 162) for determining whether a vehicle seat has been properly fastened. The trained machine learning model 362 may be implemented as a pretrained machine learning model (e.g., the pretrained machine learning model 163). In some embodiments, the machine learning training module 300 trains multiple machine learning models 362.

The training and/or validation data 367 may include labeled image data depicting vehicle seats that are properly fastened and improperly fastened. The machine learning engine 360 may pass the training and/or validation data 367 to the training module 366 and/or the validation module 368. In some embodiments, the machine learning engine 360 segments out a portion of the training data to be a validation set. For example, the machine learning engine 360 may segment out 20%, 10%, 5%, etc., of the training data for the validation data set.

The training module 366 may utilize one or more machine learning and/or vision techniques to train the machine learning model 362. In some embodiments, the machine learning model 362 is a CNN, a FCN, or another type of neural network. Accordingly, the training process may include analyzing the labels applied to the training data to determine a plurality of weights associated with the various layers of the neural network.

The validation module 368 may validate the resulting machine learning model 362 by determining a validation metric rate (e.g., accuracy, precision, recall, etc.) of the machine learning model 362. If the validation metric of the machine learning model 362 does not meet a predetermined threshold value, the validation module 368 may instruct the training module 366 to continue training the machine learning model 362 until the machine learning model 362 satisfies the validation metric.

After the machine learning model 362 satisfies the validation metric, the machine learning engine 360 may pass the resulting machine learning model 362 to a handler module 330 (e.g., the handler module 130b) of a training server (e.g., the training server 106b), which, in turn, may pass the machine learning model 362 to another handler module 330 (e.g., the handler module 130a) of an application server (e.g., the application server 106a) to be implemented as the pretrained machine learning model.

The machine learning model 362 may be developed, trained, and/or validated from multiple, parallel machine learning engines 360 and/or one or more chatbots. It should be appreciated that while specific elements, processes, devices, and/or components are described as part of example machine learning training module 300, other elements, processes, devices and/or components are contemplated and/or the elements, processes, devices, and/or components may interact in different ways and/or in differing orders, etc.

### Exemplary User Interface

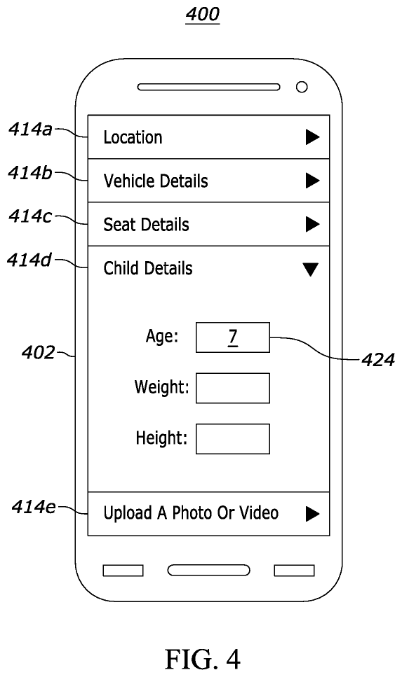

FIG. 4 depicts an exemplary graphical user interface (GUI) 400. The exemplary UI 400 may be implemented via a mobile computing device 402 (e.g., the mobile computing device 102, a computing system of a vehicle 104, and/or the mobile computing device 200b) and display the GUI 400 on the mobile computing device 402. In some embodiments, the GUI 400 is displayed in conjunction with an application (e.g., the one or more applications of the exemplary server 200a and/or the fastening validation application 288).

In some embodiments, the GUI 400 may be interactive. Additionally or alternatively, in some embodiments, the GUI 400 may be divided into one or more GUI sections (e.g., a location GUI section 414a, a vehicle details GUI section 414b, a seat details GUI section 414c, a child details GUI section 414d, and/or an upload a photo or video GUI section 414e) and include one or more interactive data input elements 424. For example, the user may interact with the one or more interactive data input elements 424 to input data (e.g., an interactive text box that allows a user to input text).

The mobile computing device 402 may be configured to utilize the data entered via the interactive data input elements 424 to generate an AR display. For example, the mobile computing device 402 may analyze the entered age, weight, and/or height data to determine an estimated side of a child that is to be placed in the vehicle seat. Accordingly, the mobile computing device 402 (and/or an application server coupled therewith) may generate overlay layer data (e.g., a 3D model of a child) that is sized based upon the input data (e.g., the input child data). The mobile computing device 402 may then generate an AR display that includes the overlay layer data depicting the 3D model of the child in the vehicle seat. In some embodiments, the mobile computing device 402 may further generate overlay data depicting 3D models of the vehicle seat straps and/or buckles when the 3D model of the child is properly fastened.

Additionally, the mobile computing device 402 may utilize information provided via the vehicle details interface and/or the vehicle seat details interface to generate the AR display. For example, the mobile computing device 402 may utilize model/make information about the vehicle and/or vehicle seat to determine the dimensions of vehicle and/or the vehicle seat (e.g., by querying a vehicle and/or vehicle seat database). The mobile computing device 402 may utilize the known dimensions to generate a virtual model of the vehicle and/or the vehicle seat to utilize when correlating the overlay layer data with the underlay layer data. Additionally, the mobile computing device 402 may utilize vehicle seat data to identify fastening data associated with the vehicle seat (e.g., fastening instructions, strap configurations for different sized children, virtual model data of the vehicle seat and/or components thereof, etc.).

### Exemplary Computing Environment

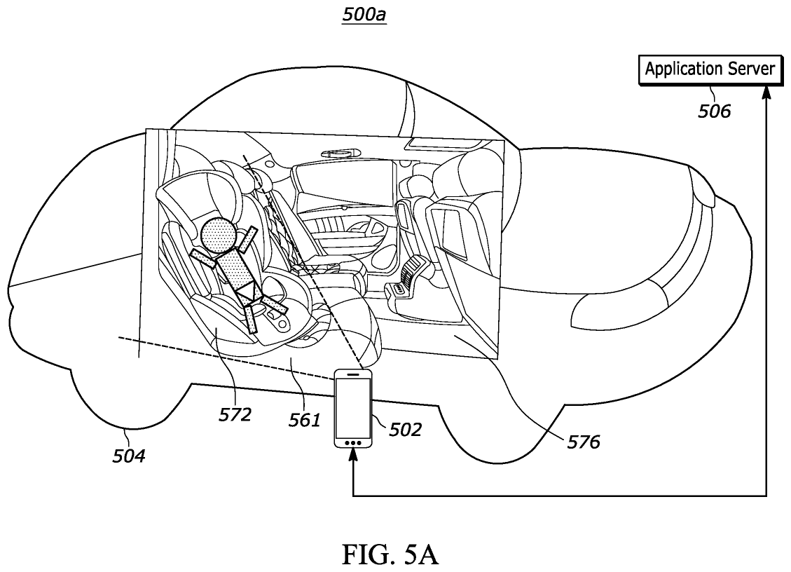

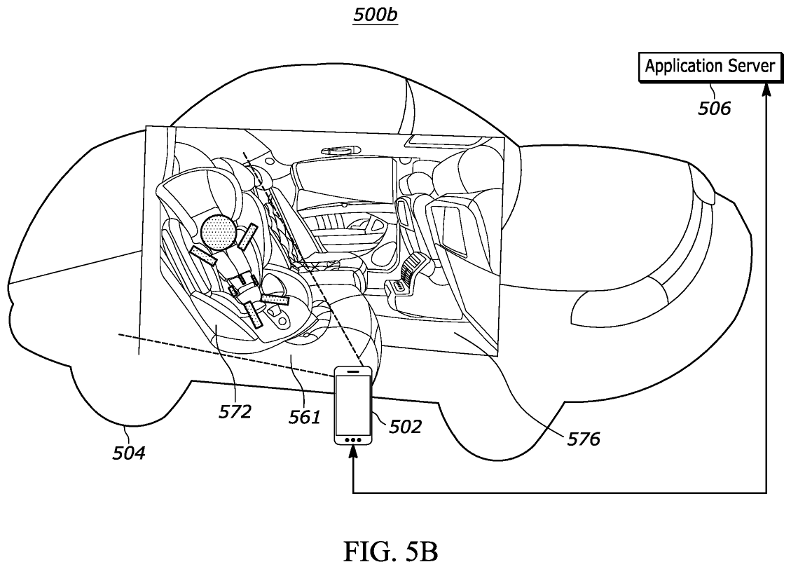

FIGS. 5A and 5B depicts an exemplary computing environment at times 500a and 500b. The exemplary environment may include a mobile computing device 502 (e.g., the mobile computing device 102, the mobile computing device 200b, and/or the mobile computing device 402), an application server 506 (e.g., the application server 106a and/or the exemplary server 200a), a vehicle 504 (e.g., the vehicle 104), and/or a vehicle seat 572 placed within an interior 576 of the vehicle 504. At an initial time 500a, an occupant is placed into the vehicle seat 572 but has not been fastened in yet. Accordingly, the AR display presented by the mobile computing device 502 may provide instructions on how to properly fasten the vehicle seat 572. At a subsequent time 500b, the occupant has been fastened into the vehicle seat 572 and the AR display presented by the mobile computing device 502 provides an indication of whether or not the vehicle seat 572 has been properly fastened (and any remedial instructions to correct an improper fastening).

The mobile computing device 502 may include one or more image sensors not shown (e.g., the one or more image sensors 262) having a FOV 561 aligned to capture underlay layer data (e.g., image data) of the vehicle seat 572. It should be appreciated that while FIG. 5A depicts the mobile computing device 502 having a smartphone form factor, in other embodiments, the mobile computing device 502 may have other form factors (e.g., smart glasses, augmented reality (AR) glasses or headsets, virtual reality (VR) glasses or headsets, extended and/or mixed reality (MR) glasses or headsets, etc.) including those described elsewhere herein.

In some embodiments, the vehicle seat 572 may be installed into the interior 576 of the vehicle 504. As illustrated in FIG. 5A, an occupant may then be placed into the vehicle seat 572.

Prior to and/or during the fastening process, the mobile computing device 502 may capture underlay layer data (e.g., image data generated by one or more image sensors) to provide guidance to the user. In some embodiments, the mobile computing device 502 may capture the underlay layer data of the vehicle seat 572 from one or more orientations. In some embodiments, the mobile computing device 502 may utilize an application (e.g., the fastening validation application 288 of the exemplary mobile computing device 200b) to capture the underlay layer data via the image sensors. In some embodiments, the mobile computing device 502 may be operated in a burst image and/or video capture mode to cause the one or more image sensors to capture multiple sets of image data within a predetermined time segment.

In some embodiments, the mobile computing device 502 may transmit the underlay layer data (and/or processed data derived therefrom) to the application server 506. For example, the mobile computing device 502 may transmit the underlay layer data as it is captured and/or in response to one or more user interactions with a chatbot. Additionally or alternatively, at least a portion of the underlay layer data may be previously stored on the mobile computing device 502 and/or the application server 506.

In some embodiments, the mobile computing device 502 processes the underlay layer data to determine that the underlay layer data is ready for analysis prior to transmitting the underlay layer data to the application server 506. As one example, the mobile computing device 502 may generate a focus quality measure, such as the focus measure operators described above, to determine a quality of image data included in the underlay layer data. If the focus quality metric does not satisfy a threshold value, the mobile computing device 502 may capture additional underlay layer data until the newly captured underlay layer data satisfies the focus quality threshold.

As another example, the mobile computing device 502 may perform image recognition, object identification, and/or other image processing techniques as described above to determine whether the vehicle seat 572 is within the image data. If the vehicle seat 572 is not recognized and/or identified in the image data, the mobile computing device 502 may capture additional underlay layer data until a vehicle seat (e.g., vehicle seat 572) is detected in the image data.

As yet another example, the mobile computing device 502 may analyze the underlay layer data to identify if there is an error preventing the detection of the vehicle seat 572. For example, the mobile computing device 502 may analyze the underlay layer data to detect one or more of an error of the position of the one or more image sensors and/or an obstruction of the FOV 561. Accordingly, the mobile computing device 502 may provide a description of the error in an alert to the user.

After obtaining the underlay layer data, the mobile computing device 502 may then process the received underlay layer data to select, identify, and/or generate overlay layer data for presentation via the AR display. In some embodiments, the overlay layer data may be selected, identified, and/or generated based upon one or more set parameters and/or other input data (e.g., vehicle data, vehicle seat data, child data, etc.). Additionally or alternatively, in some embodiments, the mobile computing device 502 may select, identify, and/or generate the overlay layer data based upon an analysis of the underlay layer data. For example, the mobile computing device 502 may perform image processing on the underlay layer data to determine the make, model, year, of the vehicle seat 572. In alternate variations of these embodiments, the application server 506 may receive the underlay layer data from the mobile computing device 502 and then process the received underlay layer data in accordance with the above embodiments. In these embodiments, at least a portion of the overlay data may be presented at the direction of the application server 506.

In response to identifying the vehicle seat type, the mobile computing device 502, and/or the application server 506, may then obtain instructional data associated with the identified vehicle seat. For example, the mobile computing device 502 may obtain textual fastening instructions, pictorial fastening instructions, and/or video/animated fastening instructions. Additionally, the mobile computing device 502, and/or application server 506, may obtain model data (e.g., a 3D model) of the identified vehicle, vehicle seat and/or component thereof to facilitate visualization of the instructions via the AR display presented by the mobile computing device 502. In some embodiments, the mobile computing device 502, and/or application server 506, processes the underlay layer data to track fastening progress to signal to the mobile computing device 502 when to present the next set of instructions via the AR display.

In some embodiments, the application server 506 may then transmit the overlay layer data (e.g., the instruction data and the corresponding the 3D models) to the mobile computing device 502. Additionally or alternatively, in some embodiments, the mobile computing device 502 may then correlate the received overlay layer data with the underlay layer data to create an AR display. The correlation may involve one or more image processing techniques to determine the placement of the overlay layer data onto the underlay layer data. For example, the mobile computing device 502 may first determine the placement of a vehicle seat 572 within the underlay layer data and then subsequently determine the placement of an instruction associated with a current fastening stage and/or a 3D model of the vehicle seat (and/or component thereof). The mobile computing device 502 may the present the AR display to the user such that the user is provided fastening instructions in a manner that aligns with the physical vehicle seat 572. If the fastening instructions include an animation, the mobile computing device 502 may execute the animation to guide the user. In some embodiments, the mobile computing device 502 provides guidance through non-AR techniques, such as by playing audio data reciting the instructions.

At the subsequent time 500b, the occupant of the vehicle seat 572 is fully fastened. Accordingly, the mobile computing device 502 may now present an AR display that indicates a properness of the fastening. It should be appreciated that while FIG. 5B depicts a state of the vehicle seat 572 being fully fastened, the following techniques may be applied at any intermediate fastening state to determine the properness of a fastening step performed by the user.

Accordingly, at the subsequent time 500b, the mobile computing device 502 may process an additional set of underlay layer data to determine whether the vehicle seat 572 is properly fastened. For example, the mobile computing device 502 may execute a pretrained machine learning model (such as the pretrained machine learning model 163) to detect whether the vehicle seat is properly fastened. As one example, a fastening validation application (such as the fastening validation application 288) may be configured to route underlay layer data to the pretrained machine learning model 163 via an application programming interface (API). In some embodiments, the mobile computing device 502 may obtain supplemental input data from a user to assist in the determination. For example, the mobile computing device 502 may obtain outputs from one or more chatbots. The mobile computing device 502 such that the mobile computing device 502 generates the appropriate overlay layer data.

In some embodiments, the mobile computing device 502 may instead determine the properness of the fastening locally. For example, the mobile computing device 502 may compare a position of a component of the vehicle seat 572, as represented by the underlay layer, to the 3D model of the vehicle seat as presented in the overlay layer of the AR display. If the position of the actual component deviates more than a threshold amount from the displayed model, the mobile computing device 502 may determine that the vehicle seat 572 has been improperly fastened. Conversely, if the position of the actual harness does not deviate more than a threshold amount from the model, the mobile computing device 502 may determine that the vehicle seat 572 has been properly fastened.

Regardless, the overlay layer data generated by the mobile computing device 502 may include an indication of whether the vehicle seat has been properly fastened. For example, the overlay layer data may include a visual warning indicating that the vehicle seat is improperly fastened (and, in some embodiments, a remedial action to resolve the user's error). As another example, the overlay layer data may change a characteristic of the 3D model of the vehicle seat based upon the determination (such as by displaying a strap and/or fastener with green highlighting when properly fastened and with red highlighting when improperly fastened).

The mobile computing device 502 may then correlate the overlay layer data with the underlay layer data to create an AR display. The correlation may involve one or more image processing techniques to determine the placement of the overlay layer data onto the underlay layer data. For example, the mobile computing device 502 may first determine the placement of a vehicle seat 572 within the underlay layer data and then subsequently determine the placement the generated overlay layer data. For example, the 3D model of the vehicle seat may be overlaid at the position of the physical vehicle seat 572. The resulting AR display may then be presented by the mobile computing device 502 to notify the user of the properness of the fastening.

Additionally, the mobile computing device 502 may notify the user of the properness of the fastening via non-AR techniques. For example, the mobile computing device 502 may generate an auditory alert (e.g., a distinct auditory alarm signal, etc.) and/or a haptic alert (e.g., a vibrational pattern).

### Exemplary AR (Augmented Reality) Display

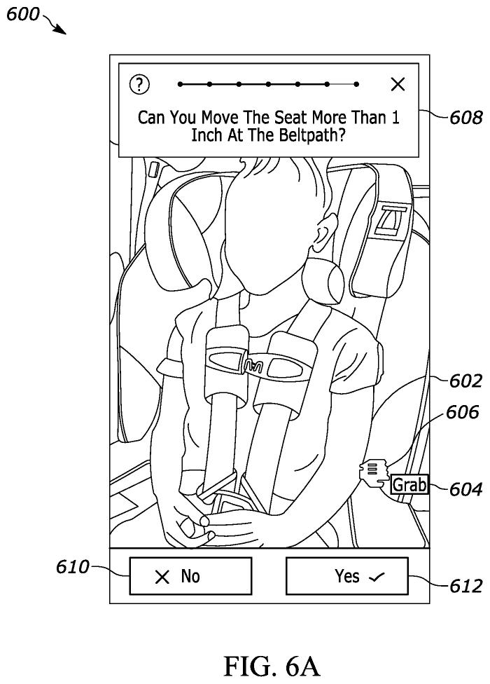

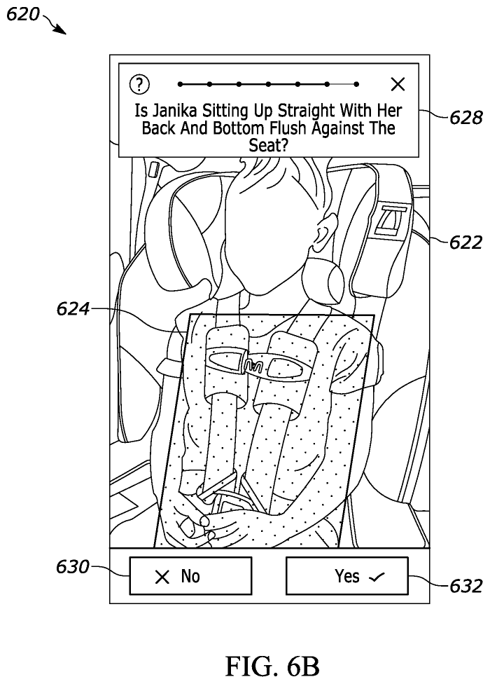

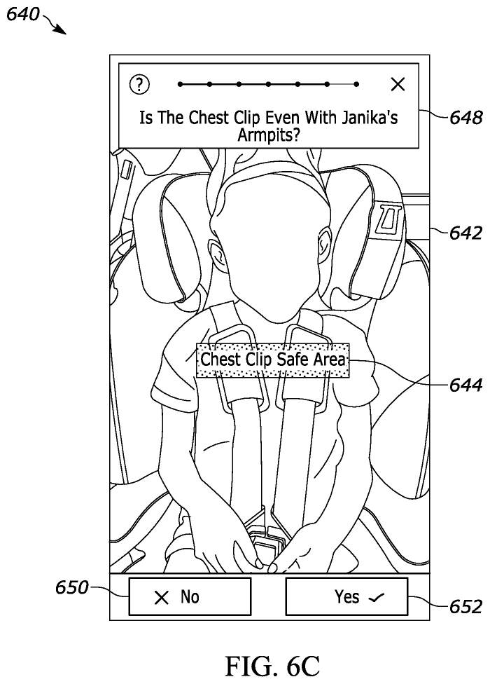

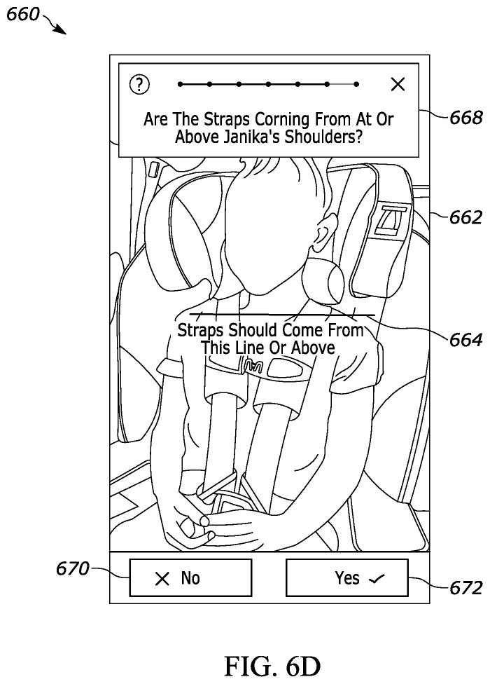

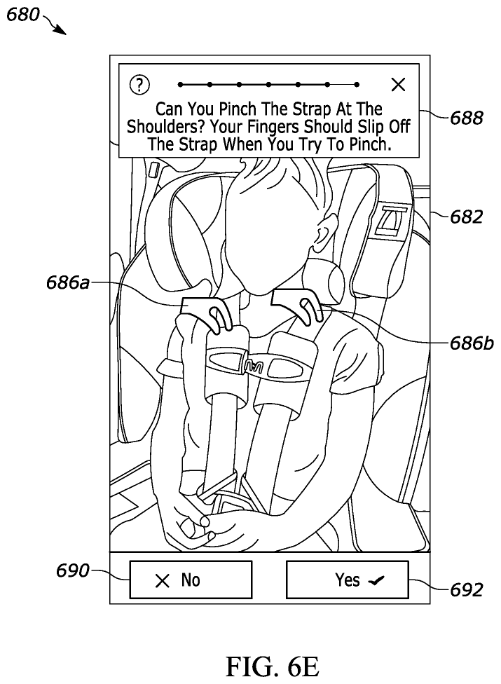

FIG. 6A depicts an exemplary AR display 600 generated by an application (e.g., the fastening validation application 288) executing on a mobile computing device (e.g., the mobile computing device 102, the mobile computing device 200b, and/or the mobile computing device 502). The exemplary AR display 600 may include underlay layer data 602, AR indications 604 and 606, interface instructions 608, and/or interface elements 610 and 612. In the illustrated scenario, an occupant has been placed into a vehicle seat and the fastening elements have been fastened. Accordingly, the AR display 600 may be configured to provide guidance to the user to determine whether the vehicle seat and/or the fastening elements thereof have been properly fastened.

As described above, the underlay layer data 602 (e.g., the underlay layer data 622, 642, 662, and/or 682 of FIGS. 6B-6E, respectively) may be captured by one or more image sensors (e.g., the one or more image sensors 262) of a mobile computing device. The application may then configure AR indications based upon a local and/or remote processing of the underlay layer data in accordance with techniques described elsewhere herein. The application may additionally configure the AR indications based upon sensor data generated by one or more sensors of a vehicle in which the vehicle seat is disposed.

In the illustrated scenario, the AR display 600 is configured to guide the user to perform a first validation of the proper fastening of the vehicle seat. Accordingly, the application may configure the AR display 600 to include interface instructions 608, such as textual instructions describing the first validation. As illustrated, the first validation is associated with verifying that the user can move the vehicle seat at least one inch at the belt path.

Additionally, the AR display 600 includes AR indications 604 and 606 that provide guidance to the user on how to perform the first validation. In particular, the AR indication 604 may indicate a region on the vehicle seat at which the validation is to be performed (e.g., the edge of the vehicle seat along the belt path) and the AR indication 606 may indicate an action to be performed by the user at the indicated region (e.g., an icon showing a grabbing hand). Accordingly, the application may analyze the underlay layer data 602 to correlate the AR indications 604 and 606 with the underlay layer data 602 (e.g., by determining the proper position of the AR indications 604 and 606 at which the user should attempt to move the vehicle seat). More particularly, the application may analyze the underlay layer data 602 to identify an edge of the vehicle seat along the belt path and position the AR indication 604 based upon the detected edge. Additionally, the application may position the AR indication 606 based upon the correlation between the AR indication 604 and the underlay layer data 602 and/or by identifying a position offset from the detected edge in the underlay layer data 602. In some embodiments, the application may instead generate and/or present an AR indication that is an animation (such as an AR animation of a generic 3D model performing the indicated test).

As illustrated, the AR display 600 may also include interface elements 610 and 612 that allow a user to provide feedback as to whether or not the vehicle seat is fastened in accordance with the first validation. In particular, the interface element 610 may be configured to enable the user to indicate that the vehicle seat is not fastened in accordance with the first validation (e.g., the vehicle seat cannot move more than 1 inch) and the interface element 612 may be configured to enable the user to indicate that the vehicle seat is fastened in accordance with the first validation (e.g., the vehicle seat can move more than 1 inch). In response to detecting an interaction with the interface element 610, the application may present instructions informing the user how to adjust the vehicle seat in a manner that complies with the first validation. On the other hand, in response to detecting an interaction with the interface element 612, the application may present a new AR display associated with performing a second validation. It should be appreciated that in some embodiments, the application may be configured to analyze the underlay layer data as the user performs the indicated validation to automatically determine whether the vehicle seat is not fastened in accordance with the first validation.

FIG. 6B depicts an exemplary AR display 620 generated by an application (e.g., the fastening validation application 288) executing on a mobile computing device (e.g., the mobile computing device 102, the mobile computing device 200b, and/or the mobile computing device 502). The exemplary AR display 620 may be displayed by the application, for example, in response to detecting a user interaction with the interface element 612. As illustrated, the AR display 620 may include underlay layer data 622, AR indication 624, interface instructions 628, and/or interface elements 630 and 632.

In the illustrated scenario, the AR display 620 is configured to guide the user to perform a second validation of the proper fastening of the vehicle seat. In particular, the AR display 620 may guide the user to verify the posture of the occupant of the vehicle seat. Accordingly, the application may configure the AR display 620 to include interface instructions 628, such as textual instructions describing the second validation (“Is Janika sitting up straight with her back and bottom flush against the seat?”).

Additionally, the AR display 620 includes AR indication 624 that provides guidance to the user on how to perform the second validation. In particular, the AR indication 624 may be a bounding box (or other shape) indicating a region in the underlay layer data at which the validation is to be performed. Accordingly, the application may analyze the underlay layer data 622 to correlate the AR indications 624 with the underlay layer data 622 (e.g., by defining an outline of the bounding box of the AR indication 624 based upon reference points (such as the base of the headrest on either side of the vehicle seat) of the vehicle seat in which the body of the occupant should be located when properly positioned within the vehicle seat). Accordingly, the application may analyze the underlay layer data 622 to define and/or position the AR indication 624 based upon the detected vehicle seat reference points.

As illustrated, the AR display 620 may also include interface elements 630 and 632 that allow a user to provide feedback as to whether or not the vehicle seat is fastened in accordance with the second validation. In particular, the interface element 630 may be configured to enable the user to indicate that the vehicle seat is not fastened in accordance with the second validation (e.g., the occupant's posture is improper) and the interface element 632 may be configured to enable the user to indicate that the vehicle seat is fastened in accordance with the second validation (e.g., the occupant's posture is proper). In response to detecting an interaction with the interface element 630, the application may present instructions informing the user how to adjust the occupant's posture in a manner that complies with the second validation. On the other hand, in response to detecting an interaction with the interface element 632, the application may present a new AR display associated with performing a third validation. It should be appreciated that in some embodiments, the application may be configured to analyze the underlay layer data 622 to automatically determine whether the vehicle seat is fastened in accordance with the second validation (e.g., that the occupant's body (or pre-determined portion thereof) is disposed within the bounding box associated with the AR indication 624).

FIG. 6C depicts an exemplary AR display 640 generated by an application (e.g., the fastening validation application 288) executing on a mobile computing device (e.g., the mobile computing device 102, the mobile computing device 200b, and/or the mobile computing device 502). The exemplary AR display 640 may be displayed by the application, for example, in response to detecting a user interaction with the interface element 632. As illustrated, the AR display 640 may include underlay layer data 642, AR indication 644, interface instructions 648, and/or interface elements 650 and 652.

In the illustrated scenario, the AR display 640 is configured to guide the user to perform a third validation of the proper fastening of the vehicle seat. As illustrated, the third validation is associated with verifying the appropriate height of the upper buckle along the occupant's chest. Accordingly, the application may configure the AR display 640 to include interface instructions 648, such as textual instructions describing the third validation (“Is the chest clip even with Janika's armpits?”).

Additionally, the AR display 640 includes AR indication 644 that provides guidance to the user on how to perform the third validation. In particular, the AR indication 644 may indicate a region in the underlay layer data 642 associated with the third validation (e.g., the region of the occupant between their armpits). Accordingly, the application may analyze the underlay layer data 642 to correlate the AR indication 644 with the underlay layer data 642 (e.g., by determining the proper position and/or defining the shape of the AR indication 644 at which the chest clip should reside when the vehicle seat is properly fastened). More particularly, the application may analyze the underlay layer data 642 to identify the occupant's armpits and define a bounding box based upon the position of the armpits.

As illustrated, the AR display 640 may also include interface elements 650 and 652 that allow a user to provide feedback as to whether or not the vehicle seat is fastened in accordance with the third validation. In particular, the interface element 650 may be configured to enable the user to indicate that the vehicle seat is not fastened in accordance with the third validation (e.g., the upper buckle is not at the appropriate height along the occupants chest) and the interface element 652 may be configured to enable the user to indicate that the vehicle seat is fastened in accordance with the third validation (e.g., the upper buckle is at the appropriate height along the occupants chest). In response to detecting an interaction with the interface element 650, the application may present instructions informing the user how to adjust the vehicle seat in a manner that complies with the third validation. In some embodiments, the application may instead generate and/or present an AR indication that is an animation (such as an AR animation of a generic 3D model) that indicates how the chest clip should be adjusted. On the other hand, in response to detecting an interaction with the interface element 652, the application may present a new AR display associated with performing a fourth validation. It should be appreciated that in some embodiments, the application may be configured to analyze the underlay layer data 642 to automatically determine whether the chest clip is within the bounding box of the AR indication 644 to automatically perform the third validation.

FIG. 6D depicts an exemplary AR display 660 generated by an application (e.g., the fastening validation application 288) executing on a mobile computing device (e.g., the mobile computing device 102, the mobile computing device 200b, and/or the mobile computing device 502). The exemplary AR display 660 may be displayed by the application, for example, in response to detecting a user interaction with the interface element 652. As illustrated, the AR display 660 may include underlay layer data 662, AR indication 664, interface instructions 668, and/or interface elements 670 and 672.

In the illustrated scenario, the AR display 660 is configured to guide the user to perform a fourth validation of the proper fastening of the vehicle seat. In particular, the AR display 660 may guide the user to verify the position of the vehicle seat straps over the shoulders of the occupant of the vehicle seat. Accordingly, the application may configure the AR display 660 to include interface instructions 668, such as textual instructions describing the fourth validation (“Are the straps coming at or above Janika's shoulders?”).

Additionally, the AR display 660 includes AR indication 664 that provides guidance to the user on how to perform the fourth validation. In particular, the AR indication 664 may be a straight line indicating a region in the underlay layer data at which the validation is to be performed. Accordingly, the application may analyze the underlay layer data 662 to correlate the AR indication 664 with the underlay layer data 662 (e.g., by defining endpoints of the line of AR indication 664 based upon reference points (such as at the top of the occupant's collarbones) on the occupant at which the vehicle seat straps should rest). Accordingly, the application may analyze the underlay later data 662 to define and/or position the AR indication 664 based upon the detected occupant reference points.

As illustrated, the AR display 660 may also include interface elements 670 and 672 that allow a user to provide feedback as to whether or not the vehicle seat is fastened in accordance with the fourth validation. In particular, the interface element 670 may be configured to enable the user to indicate that the vehicle seat is not fastened in accordance with the fourth validation (e.g., the vehicle seat straps are below the occupant's shoulders) and the interface element 672 may be configured to enable the user to indicate that the vehicle seat is fastened in accordance with the fourth validation (e.g., the vehicle seat straps are at or above the occupant's shoulders). In response to detecting an interaction with the interface element 670, the application may present instructions informing the user how to adjust the vehicle seat straps in a manner that complies with the fourth validation. In some embodiments, the application may instead generate and/or present an AR indication that is an animation (such as an AR animation of a generic 3D model) that indicates how the vehicle seat straps should be adjusted. On the other hand, in response to detecting an interaction with the interface element 672, the application may present a new AR display associated with performing a fifth validation. It should be appreciated that in some embodiments, the application may be configured to analyze the underlay layer data 662 to automatically determine whether the vehicle seat is not fastened in accordance with the fourth validation (e.g., that vehicle seat straps (or a pre-determined portion thereof) is disposed below the straight line associated with the AR indication 664).

FIG. 6E depicts an exemplary AR display 680 generated by an application (e.g., the fastening validation application 288) executing on a mobile computing device (e.g., the mobile computing device 102, the mobile computing device 200b, and/or the mobile computing device 502). The exemplary AR display 680 may be displayed by the application, for example, in response to detecting a user interaction with the interface element 672. As illustrated, the AR display 680 may include underlay layer data 682, AR indications 686a and 686b, interface instructions 688, and/or interface elements 690 and 692.

In the illustrated scenario, the AR display 680 is configured to guide the user to perform a fifth validation of the proper fastening of the vehicle seat. As illustrated, the fifth validation is associated with verifying the proper tightness of the vehicle seat straps. Accordingly, the application may configure the AR display 680 to include interface instructions 688, such as textual instructions describing the fifth validation (“Can you pinch the strap at the shoulders? Your fingers should slip off the strap when try to pinch.”).

Additionally, the AR display 680 includes AR indications 686a and 686b that provide guidance to the user on how to perform the fifth validation. In particular, the AR indications 686a and 686b may indicate regions in the underlay layer data 682 associated with the fifth validation (e.g., portion of the vehicle seat straps at shoulder height). Accordingly, the application may analyze the underlay layer data 682 to correlate the AR indications 686a and 686b with the underlay layer data 682 (e.g., by determining the proper position of the AR indications 686a and 686b at which the user should attempt to adjust the vehicle seat straps). More particularly, the application may analyze the underlay layer data 682 to identify the occupant's shoulders and define reference points on the vehicle seat straps based upon the position of the occupant's shoulders.

As illustrated, the AR display 680 may also include interface elements 690 and 692 that allow a user to provide feedback as to whether or not the vehicle seat is fastened in accordance with the fifth validation. In particular, the interface element 690 may be configured to enable the user to indicate that the vehicle seat is not fastened in accordance with the fifth validation (e.g., the tightness of the vehicle seat straps is improper) and the interface element 692 may be configured to enable the user to indicate that the vehicle seat is fastened in accordance with the fifth validation (e.g., the tightness of the vehicle seat straps is proper). In response to detecting an interaction with the interface element 690, the application may present instructions informing the user how to adjust the vehicle seat in a manner that complies with the fifth validation. In some embodiments, the application may instead generate and/or present an AR indication that is an animation (such as an AR animation of a generic 3D model) that indicates how to perform the test associated with the validation and/or how the vehicle seat straps should be adjusted. On the other hand, in response to detecting an interaction with the interface element 692, the application may present a new AR display associated with performing a sixth validation. It should be appreciated that in some embodiments, the application may be configured to analyze the underlay layer data 682 while the user performs the tightness check to automatically determine whether the vehicle seat straps are not fastened in accordance with the fifth validation.

For example, if the lower buckle is properly fastened and the upper buckle is at an incorrect height, the AR indications may include a first indication that the lower buckle is properly fastened (such as by displaying the 3D model of the lower buckle in green) and a second indication that the upper buckle is improperly fastened (such as by displaying the 3D model of the upper buckle in red). Further, the mobile computing device may identify which component, if any, is improperly fastened, and provide appropriate remedial instruction and/or guidance to the user.

It should be appreciated that while FIGS. 6A-6E depict one example series of validations, in other embodiments, the validations may be performed in any order. Additionally, in other embodiments, additional, fewer, and/or alternative validations may be implemented.

### Exemplary Method of Monitoring Installation of Vehicle Seats

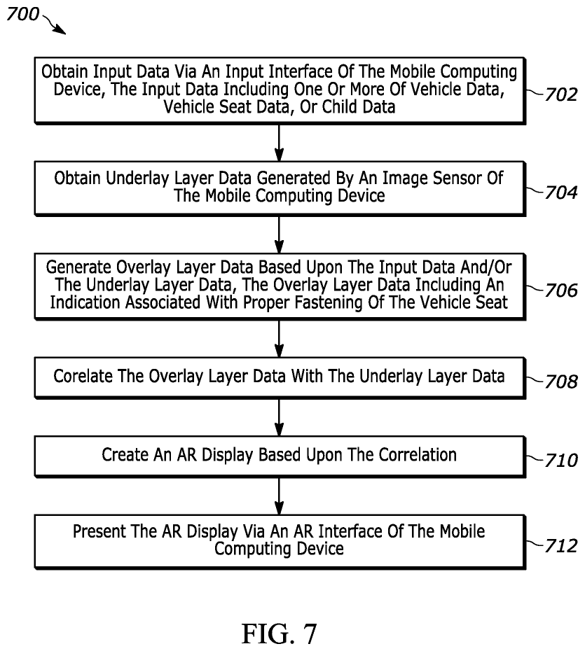

FIG. 7 depicts an exemplary computer-implemented method 700 of using augmented reality (AR) for validating proper fastening of a vehicle seat via an application (e.g., the fastening validation application 288) executing on a mobile computing device (e.g., the mobile computing device 102, the mobile computing device 200b, and/or the mobile computing device 502). The method 700 may employ any of the techniques, methods, and systems described herein with respect to FIGS. 1-6E.

The method 700 may begin at block 702 when the application executing on the mobile computing device causes one or more processors (e.g., the one or more processors 211b), to obtain input data via an input interface (e.g., the GUI 400) of the mobile computing device, the input data including one or more of vehicle data (e.g., the make, model, year, etc.), vehicle seat data (e.g., the make, model, year, etc. of the vehicle seat), and/or child data (e.g., an age of the child, a height of the child, a weight of the child, etc.).

At block 704, the application may cause the one or more processors to obtain underlay layer data (e.g., any of the underlay layer data 602, 622, 642, 662, and/or 682) generated by an image sensor (e.g., the image sensors 262) of the mobile computing device. In some embodiments, the underlay layer data may be raw image data obtained by the image sensors. In some embodiments, the image data may include component set of image data captured from multiple perspectives and/or orientations.

At block 706, the application may cause the one or more processors to generate overlay layer data (e.g., the AR indications 604 and 606) based upon the input data and/or the underlay layer data. In some embodiments, the mobile computing device may be communicatively coupled with one or more sensors of a vehicle in which the vehicle seat resides (e.g., the vehicle 104), and the exemplary computer-implemented method may further comprise obtaining, from the one or more sensors, sensor data and the application causing the one or more processor to generate overlay layer data based upon the sensor data. In some embodiments, the overlay layer data may include an indication and/or a representation associated with proper fastening of the vehicle seat. In these embodiments, the indication associated with proper fastening of the vehicle seat may indicate one or more of: (i) anchorage of the vehicle seat, (ii) orientation of an occupant in the vehicle seat, (iii) positioning of one or more fastening elements relative to an occupant's armpits, (iv) positioning of one or more fastening elements relative to an occupant's neckline, and/or (v) tightness of one or more fastening element.

At block 708, the application may cause the one or more processors to correlate the overlay layer data with the underlay layer data. In some embodiments, corelating the overlay layer data with the underlay layer data comprises the application causing the one or more processors to (1) analyze the underlay layer data to detect an occupant of the vehicle seat, (2) determine an orientation of the occupant when properly fastened into the vehicle seat, and/or (3) corelate the indication associated with the proper fastening of the vehicle seat with a position in the AR display indicative of the orientation of the occupant when properly fastened into the vehicle seat. In some embodiments, corelating the overlay layer data with the underlay layer data comprises the application causing the one or more processors to (1) analyze the underlay layer data to detect one or more fastening elements of the vehicle seat and an occupant of the vehicle seat, (2) determine a positioning of the one or more fastening elements relative to the occupant when properly fastened, and/or (3) correlate the indication associated with the proper fastening of the vehicle seat with a position in the AR display indicative of the positioning of the one or more fastening elements relative to the occupant when properly fastened. In some embodiments, corelating the overlay layer data with the underlay layer data comprises the application causing the one or more processors to (1) analyze the underlay layer data to detect the vehicle seat, (2) determine a positioning of the vehicle seat when properly fastened, and/or (3) correlate the indication associated with the proper fastening of the vehicle seat with a position in the AR display indicative of the positioning of the vehicle seat when properly fastened.

At block 710, the application may cause the one or more processors to create an AR display (e.g., the AR displays 600, 620, 640, 660, and/or 680) based upon the correlation. In some embodiments, the application may also analyze the underlay layer data and the overlay layer data to detect an alignment between the vehicle seat, one or more fastening elements of the vehicle seat, and/or an orientation of an occupant of the vehicle seat. In these embodiments, the application may cause the one or more processors to update the AR interface based upon the detected alignment.

In a variation of these embodiments, updating the AR interface may further comprise the application causing the one or more processors to detect that the alignment between the vehicle seat, one or more fastening elements of the vehicle seat, and/or an orientation of an occupant of the vehicle seat is improper and generate a notification indicating that the vehicle seat is properly fastened based upon the detected alignment. In another variation of these embodiments, updating the AR interface may further comprise the application causing the one or more processors to detect that the alignment between the vehicle seat, one or more fastening elements of the vehicle seat, and/or an orientation of an occupant of the vehicle seat is improper and generate a notification indicating that the vehicle seat is not properly fastened based upon the detected alignment. In yet another variation of these embodiments, updating the AR interface may further comprise the application generating one or more of: (i) a visual notification, (ii) a textual notification, (iii) an audio notification, or (iv) a haptic notification. In these embodiments, the visual notification may be a change in display of the indication associated with proper fastening of the vehicle seat.

At block 712, the application may cause the one or more processors to present the AR display via an AR interface (e.g., the interactive UI 132a of the training server 106b, and/or exemplary GUI 400 of the mobile computing device) of the mobile computing device. In some embodiments, presenting the AR display via the AR interface may comprise presenting one or more interface elements configured to detect user input indicative of proper alignment between the vehicle seat, one or more fastening elements of the vehicle seat, or an orientation of an occupant of the vehicle seat with the indication associated with the proper fastening of the vehicle seat. In these embodiments, the mobile computing device may compare a portion of the underlay layer data (e.g., a location of a fastening element within the underlay data) to a correlated portion of the overlay layer data (e.g., a location at which the fastening element is to be positioned when the vehicle seat is properly fastened) to automatically determine whether the vehicle seat is properly fastened.

In the instances where the mobile computing device determines that the vehicle seat is improperly fastened, the mobile computing device may include in the AR display an alert that the vehicle seat is not properly fastened as well as instructions on how to properly fasten the vehicle seat. Alternatively, in the instances where the mobile computing device determines that the vehicle seat is properly fastened, the mobile computing device may create a second AR display configured to generate a second indication associated with proper fastening of the vehicle seat. The method 700 may include additional, fewer, and/or alternative steps, including those described elsewhere herein.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, some embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules may provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may, at a later time, access the memory device to retrieve and process the stored output. Modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “receiving,” “analyzing,” “generating,” “creating,” “storing,” “deploying,” “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other.

As used herein any reference to “some embodiments” means that a particular element, feature, structure, or characteristic described in connection with the embodiment may be included in at least one embodiment. The appearances of the phrase “some embodiments” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein.

Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the above-described detailed description be regarded as illustrative rather than limiting, and that it be understood that it is the following claims, including all equivalents, that are intended to define the spirit and scope of this invention.

What is claimed:

1. A computer-implemented method of using augmented reality (AR) for validating proper fastening of a vehicle seat via an application executing on a mobile computing device, the method comprising:
the application causing one or more processors of the mobile computing device to obtain input data via an input interface of the mobile computing device, the input data including one or more of vehicle data, vehicle seat data, or child data;
the application causing the one or more processors to obtain underlay layer data generated by an image sensor of the mobile computing device;
the application causing the one or more processors to generate overlay layer data based upon the input data and/or the underlay layer data, the overlay layer data including an indication associated with proper fastening of the vehicle seat;
the application causing the one or more processors to corelate the overlay layer data with the underlay layer data;
the application causing the one or more processors to create an AR display based upon the correlation; and
the application causing the one or more processors to present the AR display via an AR interface of the mobile computing device.

2. The computer-implemented method of claim 1, wherein the mobile computing device is communicatively coupled with one or more sensors of a vehicle in which the vehicle seat resides, and the method further comprises:
obtaining, from the one or more sensors, sensor data; and
the application causing the one or more processors to generate overlay layer data based upon the sensor data.

3. The computer-implemented method of claim 1, wherein corelating the overlay layer data with the underlay layer data comprises:
the application causing the one or more processors to analyze the underlay layer data to detect an occupant of the vehicle seat;
the application causing the one or more processors to determine an orientation of the occupant when properly fastened into the vehicle seat; and
the application causing the one or more processors to correlate the indication associated with the proper fastening of the vehicle seat with a position in the AR display indicative of the orientation of the occupant when properly fastened into the vehicle seat.

4. The computer-implemented method of claim 1, wherein corelating the overlay layer data with the underlay layer data comprises:
the application causing the one or more processors to analyze the underlay layer data to detect one or more fastening elements of the vehicle seat and an occupant of the vehicle seat;
the application causing the one or processors to determine a positioning of the one or more fastening elements relative to the occupant when properly fastened; and
the application causing the one or more processors to correlate the indication associated with the proper fastening of the vehicle seat with a position in the AR display indicative of the positioning of the one or more fastening elements relative to the occupant when properly fastened.

5. The computer-implemented method of claim 1, wherein corelating the overlay layer data with the underlay layer data comprises:
the application causing the one or more processors to analyze the underlay layer data to detect the vehicle seat;
the application causing the one or more processors to determine a positioning of the vehicle seat when properly fastened; and
the application causing the one or more processors to correlate the indication associated with the proper fastening of the vehicle seat with a position in the AR display indicative of the positioning of the vehicle seat when properly fastened.

6. The computer-implemented method of claim 1, further comprising:
analyzing, by the application, the underlay layer data and the overlay layer data to detect an alignment between the vehicle seat, one or more fastening elements of the vehicle seat, and/or an orientation of an occupant of the vehicle seat; and
the application causing the one or more processors to update the AR interface based upon the detected alignment.

7. The computer-implemented method of claim 6, wherein updating the AR interface comprises:
the application causing the one or more processors to detect that the alignment between the vehicle seat, one or more fastening elements of the vehicle seat, and/or an orientation of an occupant of the vehicle seat is proper; and
the application causing the one or more processors to generate a notification indicating that the vehicle seat is properly fastened based upon the detected alignment.

8. The computer-implemented method of claim 6, wherein updating the AR interface comprises:
the application causing the one or more processors to detect that the alignment between the vehicle seat, one or more fastening elements of the vehicle seat, and/or an orientation of an occupant of the vehicle seat is improper; and
the application causing the one or more processors to generate a notification indicating that the vehicle seat is not properly fastened based upon the detected alignment.

9. The computer-implemented method of claim 6, wherein updating the AR interface comprises:
the application generating one or more of: (i) a visual notification, (ii) a textual notification, (iii) an audio notification, or (iv) a haptic notification.

10. The computer-implemented method of claim 1, wherein presenting the AR display via the AR interface comprises:
presenting one or more interface elements configured to detect user input indicative of proper alignment between the vehicle seat, one or more fastening elements of the vehicle seat, or an orientation of an occupant of the vehicle seat with the indication associated with the proper fastening of the vehicle seat.

11. The computer-implemented method of claim 1, further comprising:
detecting proper alignment between the vehicle seat, one or more fastening elements of the vehicle seat, or an orientation of an occupant of the vehicle seat with the indication associated with the proper fastening of the vehicle seat; and
in response to detecting the proper alignment, creating a second AR display configured to generate a second indication associated with proper fastening of the vehicle seat.

12. The computer-implemented method of claim 1, wherein the indication associated with proper fastening of the vehicle seat indicates one or more of: (i) anchorage of the vehicle seat, (ii) orientation of an occupant in the vehicle seat, (iii) positioning of one or more fastening elements relative to an occupant's armpits, (iv) positioning of one or more fastening elements relative to an occupant's neckline, or (v) tightness of one or more fastening element.

13. A mobile computing system for using an augmented reality (AR) enabled application to validate proper fastening of a vehicle seat comprising:
an image sensor;
one or more processors; and
a non-transitory program memory coupled to the one or more processors and storing executable instructions that, when executed by the one or more processors, cause the mobile computing system to:
obtain input data via an input interface, the input data including one or more of vehicle data, vehicle seat data, or child data;
obtain underlay layer data generated by the image sensor;
generate overlay layer data based upon the input data and/or the underlay layer data, the overlay layer data including an indication associated with proper fastening of the vehicle seat;
correlate the overlay layer data with the underlay layer data;
create an AR display based upon the correlation; and
present the AR display via an AR interface.

14. The mobile computing system of claim 13, wherein the mobile computing device is communicatively coupled with one or more sensors of a vehicle in which the vehicle seat resides, and the mobile computing system is configured to:
obtain, from the one or more sensors, sensor data; and
generate overlay layer data based upon the sensor data.

15. The mobile computing system of claim 13, wherein the instructions, when executed, further cause the mobile computing system to:
analyze the underlay layer data to detect an occupant of the vehicle seat; and
determine an orientation of the occupant when properly fastened into the vehicle seat; and
correlate the indication associated with the proper fastening of the vehicle seat with a position in the AR display indicative of the orientation of the occupant when properly fastened into the vehicle seat.

16. The mobile computing system of claim 13, wherein the instructions, when executed, further cause the mobile computing system to:
analyze the underlay layer data to detect one or more fastening elements of the vehicle seat and an occupant of the vehicle seat;
determine a positioning of the one or more fastening elements relative to the occupant when properly fastened; and
correlate the indication associated with the proper fastening of the vehicle seat with a position in the AR display indicative of the positioning of the one or more fastening elements relative to the occupant when properly fastened.

17. The mobile computing system of claim 13, wherein the instructions, when executed, further cause the mobile computing system to:
analyze the underlay layer data to detect the vehicle seat;
determine a positioning of the vehicle seat when properly fastened; and
correlate the indication associated with the proper fastening of the vehicle seat with a position in the AR display indicative of the positioning of the vehicle seat when properly fastened.

18. The mobile computing system of claim 13, wherein the instructions, when executed, further cause the mobile computing system to:
analyze the underlay layer data and the overlay layer data to detect an alignment between the vehicle seat, one or more fastening elements of the vehicle seat, and/or an orientation of an occupant of the vehicle seat; and
update the AR interface based upon the detected alignment.

19. The mobile computing system of claim 13, wherein the instructions, when executed, further cause the mobile computing system to:
detect proper alignment between the vehicle seat, one or more fastening elements of the vehicle seat, or an orientation of an occupant of the vehicle seat with the indication associated with the proper fastening of the vehicle seat; and
in response to detecting the proper alignment, create a second AR display configured to generate a second indication associated with proper fastening of the vehicle seat.

20. A tangible, non-transitory computer-readable medium storing executable instructions of using augmented reality (AR) for validating proper fastening of a vehicle seat, the instructions, when executed by one or more processors of a mobile computing system, cause a mobile computing system to:
obtain input data via an input interface of a mobile computing device, the input data including one or more of vehicle data, vehicle seat data, or child data;
obtain underlay layer data generated by an image sensor of the mobile computing device;
generate overlay layer data based upon the input data and/or the underlay layer data, the overlay layer data including an indication associated with proper fastening of the vehicle seat;
correlate the overlay layer data with the underlay layer data;
create an AR display based upon the correlation; and
present the AR display via an AR interface of the mobile computing device.
